(19) United States
(12) Patent Application Publication
(10) Pub. No.: US 2023/0086388 A1
(43) Pub. Date: Mar. 23, 2023

(54) REGISTRATION APPARATUS AND CALLBACK METHOD

(71) Applicant: TOSHIBA TEC KABUSHIKI KAISHA, Tokyo (JP)

(72) Inventor: Takashi IIZUKA, Izunokuni Shizuoka (JP)

(21) Appl. No.: 17/731,713

(22) Filed: Apr. 28, 2022

(30) Foreign Application Priority Data
Sep. 21, 2021 (JP) 2021-152965

(51) Int. Cl. G06Q 20/12

(52) U.S. Cl. CPC G06Q 20/12

(57) ABSTRACT

According to an embodiment, a registration apparatus transmits payment data including registered information of a commodity to any one of a plurality of payment apparatuses. The registration apparatus determines which payment apparatus of the plurality of payment apparatuses is a payment apparatus that takes over execution of payment processing based on the transmitted payment data. The registration apparatus instructs the payment apparatus lastly determined to stop the payment processing based on the transmitted payment data and to call back the payment data via the communication device in response to a reception of a callback operation by an input device.

### CROSS-REFERENCE TO RELATED APPLICATIONS

This application is based upon and claims the benefit of priority from the prior Japanese Patent Application No. 2021-152965, filed on Sep. 21, 2021, the entire contents of which are incorporated herein by reference.

### FIELD

An embodiment described herein generally relates to a registration apparatus and a callback method for a registration apparatus.

### BACKGROUND

There is known a semi-self-service checkout system in which a registration apparatus for registering the content of a transaction and a payment apparatus for paying a price relating to the transaction are separately provided. In such a checkout system, a so-called callback function is known, which allows the payment data to be returned from the payment apparatus to the registration apparatus and the content of the transaction to be changed, for example, even after the payment data for paying the price relating to the transaction in the payment apparatus is transferred from the registration apparatus to the payment apparatus.

Incidentally, since the payment apparatus may be operated by a customer who is unfamiliar with the operation for the callback described above, it is generally configured to receive the payment data transmitted from one registration apparatus by any one of a plurality of payment apparatuses. If such a configuration is provided, the operator of the registration apparatus has to designate which payment apparatus is to be called back, which is troublesome. In view of such circumstances, it has been desired to be able to reduce the burden of the callback on the operator.

### BRIEF DESCRIPTION OF THE DRAWINGS

FIG. 1 is a block diagram showing a checkout system according to an embodiment.

FIG. 2 is a flowchart showing registration processing of a processor of a registration apparatus according to the embodiment.

FIG. 3 is a flowchart showing the registration processing of the processor of the registration apparatus according to the embodiment.

FIG. 4 is a diagram showing a registration screen according to the embodiment.

FIG. 5 is a diagram showing a standby screen according to the embodiment.

FIG. 6 is a diagram showing a selection screen according to the embodiment.

### DETAILED DESCRIPTION

According to one embodiment, a registration apparatus performs registration processing for registering information of a commodity as a transaction target and transmits payment data including the registered information of the commodity to any one of a plurality of payment apparatuses to perform payment processing for the transaction. The registration apparatus includes an input device, a memory, a communication device, and a processor. The input device receives a callback operation for instructing the payment apparatus to return the transmitted payment data, the callback operation being performed by an operator. The memory stores transaction information including a commodity list for storing the information of the commodity for the registration processing. The communication device performs communication for exchanging data with the plurality of payment apparatuses. The processor includes, when the information of the commodity is acquired in a state of the registration processing, the acquired information of the commodity in the commodity list to update the commodity list stored in the memory. The processor generates the payment data including the commodity list stored in the memory and transmits the generated payment data to a predetermined payment apparatus of the plurality of payment apparatuses via the communication device. The processor determines which payment apparatus of the plurality of payment apparatuses is a payment apparatus that takes over execution of the payment processing based on the transmitted payment data. The processor instructs the payment apparatus lastly determined to stop the payment processing based on the transmitted payment data via the communication device in response to the reception of the callback operation by the input device. The processor calls back the transmitted payment data from the payment apparatus, to which the instruction has been issued, via the communication device. Further, the processor stores the commodity list included in the called-back payment data in the memory again to return to the state of the registration processing before the payment data is transmitted.

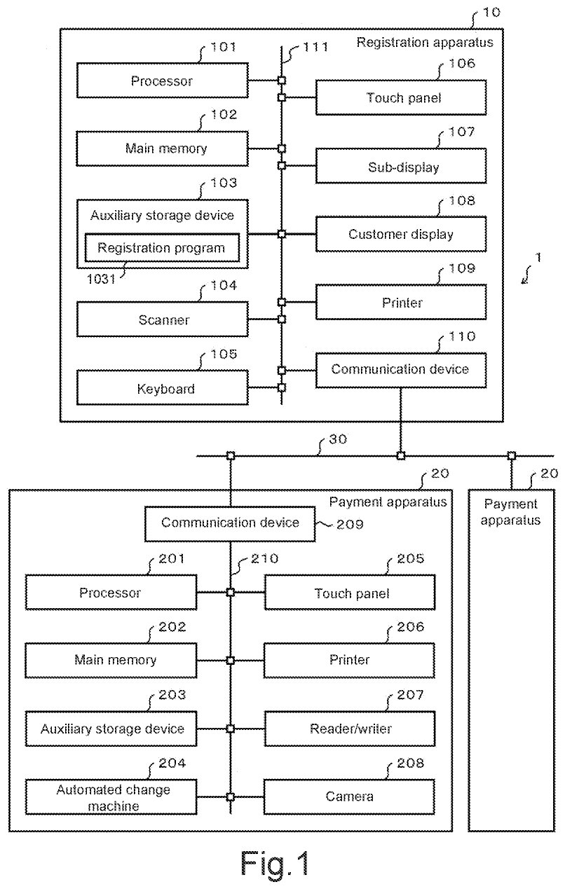

Hereinafter, an example of an embodiment will be described with reference to the drawings. The same reference symbols in the drawings will denote the same or similar portions. FIG. 1 is a block diagram showing a checkout system 1 according to this embodiment. As shown in FIG. 1, the checkout system 1 includes at least one registration apparatus 10 and a plurality of payment apparatuses 20. In the following, for the sake of simplicity, the checkout system 1 including one registration apparatus 10 and two payment apparatuses 20 will be described. In many cases, however, the checkout system 1 includes more registration apparatuses 10 and payment apparatuses 20. The checkout system 1 may include any number of registration apparatuses 10 and payment apparatuses 20, and the ratio of the registration apparatuses 10 to the payment apparatuses 20 is also optionally set.

In the registration apparatus 10, a clerk in charge of a so-called checker is the operator thereof. In the payment apparatus 20, a customer who pays the price of a transaction in the store is the operator thereof. However, some of the operations of the registration apparatus 10 may be performed by a customer. The payment apparatus 20 may also be operated by a clerk. The registration apparatus 10 performs registration processing for registering a commodity to be purchased by a customer as a purchased commodity. The registration apparatus 10 also transmits payment data to pay for the purchased commodity registered for one transaction so as to be processed in any of the payment apparatuses 20.

When receiving the payment data transmitted from the registration apparatus 10, the payment apparatus 20 performs payment processing for paying the price of the transaction on the basis of the payment data. Note that the plurality of payment apparatuses 20 may have the same configuration and perform similar payment processing. Note that the payment apparatus 20 may also perform calculation processing for the amount of money to be paid in the payment processing. If the payment apparatus 20 has such a calculation processing function, the payment apparatus 20 is also referred to as a checkout apparatus or a checkout machine. However, the calculation processing may be performed by the registration apparatus 10. The registration apparatus 10 and the payment apparatus 20 are each connected to a local area network (LAN) 30. Instead of the LAN 30, another communication network such as the Internet can also be used.

The registration apparatus 10 includes a processor 101, a main memory 102, an auxiliary storage device 103, a scanner 104, a keyboard 105, a touch panel 106, a sub-display 107, a customer display 108, a printer 109, a communication device 110, and a transmission path 111. The processor 101, the main memory 102, and the auxiliary storage device 103 are connected to each other by the transmission path 111 to form a computer. The computer performs information processing for controlling the registration apparatus 10.

The processor 101 corresponds to the central part of the computer. The processor 101 executes information processing according to various information processing programs such as an operating system, firmware, and an application program, to thereby control each unit to implement various functions as the registration apparatus 10.

The main memory 102 corresponds to a main memory part of the computer. The main memory 102 includes a nonvolatile memory area and a volatile memory area. The main memory 102 may store some of the above-mentioned various information processing programs in the nonvolatile memory area. Further, the main memory 102 may store data required for the processor 101 to execute processing for controlling each unit in the nonvolatile or volatile memory area. The volatile memory area of the main memory 102 is used as a work area in which data is appropriately rewritten by the processor 101.

The auxiliary storage device 103 corresponds to an auxiliary storage part of the computer. For the auxiliary storage device 103, for example, an electric erasable programmable read-only memory (EEPROM), a hard disc drive (HDD), a solid-state drive (SSD), or other various well-known storage devices can be used. The auxiliary storage device 103 stores some of the above-mentioned various information processing programs. One of the information processing programs stored by the auxiliary storage device 103 is a registration program 1031, which is described regarding registration processing to be described below. The auxiliary storage device 103 stores the data to be used by the processor 101 to perform various types of processing and the data generated in the processing of the processor 101.

In the registration apparatus 10, the registration program 1031 is generally transferred by being stored in the auxiliary storage device 103. However, the hardware of the registration apparatus 10 may be transferred without the registration program 1031 stored in the auxiliary storage device 103. Alternatively, the hardware of the registration apparatus 10 may be transferred with another information processing program of the same type as the registration program 1031 stored in the auxiliary storage device 103. In this case, the registration program 1031 is written to the auxiliary storage device 103, e.g., by the processor 101, under the instruction by a maintenance worker. The transfer of the registration program 1031 may be performed by recording on a removable recording medium such as a magnetic disk, a magneto-optical disk, an optical disc, or a semiconductor memory, or may be performed via a network.

The scanner 104 images a commodity by a built-in camera through a scanner window. The scanner 104 identifies an optically readable code symbol, such as a bar code or a two-dimensional code, displayed on the commodity by image processing. The scanner 104 then outputs the data represented by the identified code symbol to the processor 101. Note that other types of well-known devices that use laser-light reflection to identify a code symbol can also be used as the scanner 104. The scanner 104 may have a function of identifying a commodity using the object recognition technology based on the features of the image of the commodity itself. Apart from the scanner 104, the registration apparatus 10 may include other scanners such as a handy scanner. Further, the registration apparatus 10 may include the other scanners and may exclude the scanner 104.

The keyboard 105 includes a numeric keypad, a plurality of function keys, and the like. The keyboard 105 receives various instructions made by an operator through a key operation. The touch panel 106 includes a display device and a touch sensor. The display device displays any screen such as a graphical user interface (GUI) screen under the control of the processor 101. As the display device, for example, a well-known device such as a color liquid crystal display (LCD) can be used. The touch sensor is disposed to be superimposed on the display surface of the display device. The touch sensor detects the position touched by the operator on the display surface of the display device and transmits such position information to the processor 101. As the touch sensor, a well-known device can be used. The operation surface of the touch panel 106 is directed to the place where a clerk who operates the registration apparatus 10 is to be located.

The sub-display 107 displays, for example, any screen such as a monitoring screen for allowing the clerk to monitor the state of the payment apparatus 20 under the control of the processor 101. As the sub-display 107, for example, a well-known display device such as a color LCD can be used. The display surface of the sub-display 107 is directed to the place where the clerk who operates the registration apparatus 10 is to be located. As the sub-display 107, a touch panel may be used.

The customer display 108 is directed to the place where a customer waiting for the completion of the registration processing for the commodity is to be located. The customer display 108 displays any screen for notifying the customer of any information under the control of processor 101. The screen to be displayed by the customer display 108 is, for example, a screen representing a registration result or a screen representing promotional information. As the customer display 108, for example, a well-known device such as a color LCD can be used. As the customer display 108, a touch panel can also be used.

The printer 109 is, for example, a thermal printer or a dot-impact printer. The printer 109 issues a receipt by printing various character strings, images, and the like on a receipt sheet. The communication device 110 performs communication via the LAN 30. The transmission path 111 transmits data to be exchanged between the connected units. For the transmission path 111, well-known buses including various buses such as a system bus and various interface circuits for connecting those buses and each unit to each other can be used.

The payment apparatus 20 includes a processor 201, a main memory 202, an auxiliary storage device 203, an automated change machine 204, a touch panel 205, a printer 206, a reader/writer 207, a camera 208, a communication device 209, and a transmission path 210. The processor 201, the main memory 202, and the auxiliary storage device 203 are connected to each other by the transmission path 210 to form a computer. The computer performs information processing for controlling the payment apparatus 20.

The processor 201 corresponds to the central part of the computer. The processor 201 executes information processing according to various information processing programs such as an operating system, firmware, and an application program, to thereby control each unit to implement various functions as the payment apparatus 20.

The main memory 202 corresponds to a main memory part of the computer. The main memory 202 includes a nonvolatile memory area and a volatile memory area. The main memory 202 may store some of the above-mentioned various information processing programs in the nonvolatile memory area. Further, the main memory 202 may store data required for the processor 201 to execute processing for controlling each unit in the nonvolatile or volatile memory area. The volatile memory area of the main memory 202 is used as a work area in which data is appropriately rewritten by the processor 201.

The auxiliary storage device 203 corresponds to an auxiliary storage part of the computer. The auxiliary storage device 203 may store some of the various information processing programs described above. For the auxiliary storage device 203, for example, an EEPROM, an HDD, an SSD, or other various well-known storage devices can be used. The auxiliary storage device 203 stores the data to be used by the processor 201 to perform various types of processing and the data generated in the processing of the processor 201.

The automated change machine 204 collects coins and bills to be input. Further, the automated change machine 204 discharges coins and bills as change. The touch panel 205 includes a display device and a touch sensor. The display device displays any screen such as a GUI screen under the control of the processor 201. As the display device, for example, a well-known device such as a color LCD can be used. The touch sensor is disposed to be superimposed on the display surface of the display device. The touch sensor detects the position touched by the operator on the display surface of the display device and transmits such position information to the processor 201. As the touch sensor, a well-known device can be used.

The printer 206 is, for example, a thermal printer or a dot-impact printer. The printer 206 issues a receipt or acknowledgment by printing various character strings, images, and the like on a receipt sheet. The reader/writer 207 reads data recorded on a recording medium such as a card or an IC chip. The reader/writer 207 writes data to the recording medium. The card includes cards for payment such as a credit card, a debit card, an electronic money card, and a prepaid card. In addition to those cards, the card may include various cards for recording information relating to payment processing, such as a member card and a reward point card. In addition to the various cards described above, an IC chip may be provided to an information terminal such as a smart phone. The reader/writer 207 may be any of a magnetic type, a contact type, and a contactless type, and may include a plurality of types of devices.

The camera 208 images the range including the operation surface of the payment apparatus 20 and its surroundings in a bird's-eye view. In other words, the camera 208 images a state in which the payment apparatus 20 is operated. Note that an existing imaging device such as an imaging device that captures moving images or an imaging device that intermittently captures still images can be used as the camera 208. The communication device 209 performs communication via the LAN 30. The transmission path 210 transmits data to be exchanged between the connected units. For the transmission path 210, well-known buses including various buses such as a system bus and various interface circuits for connecting those buses and each unit to each other can be used.

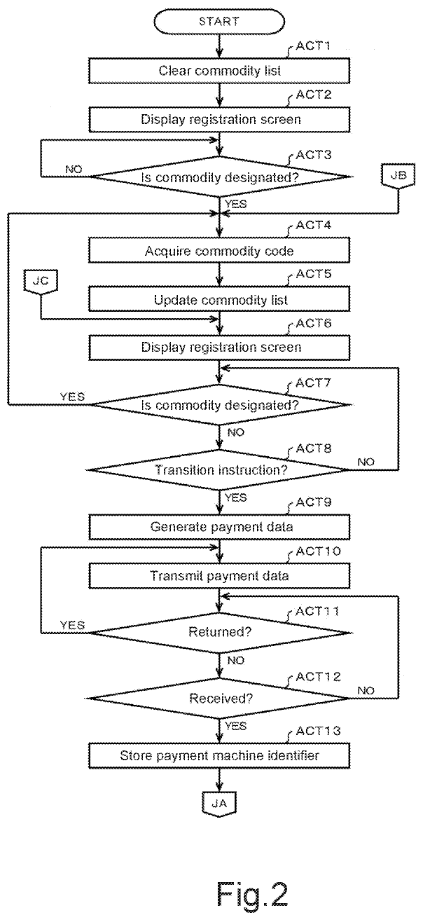

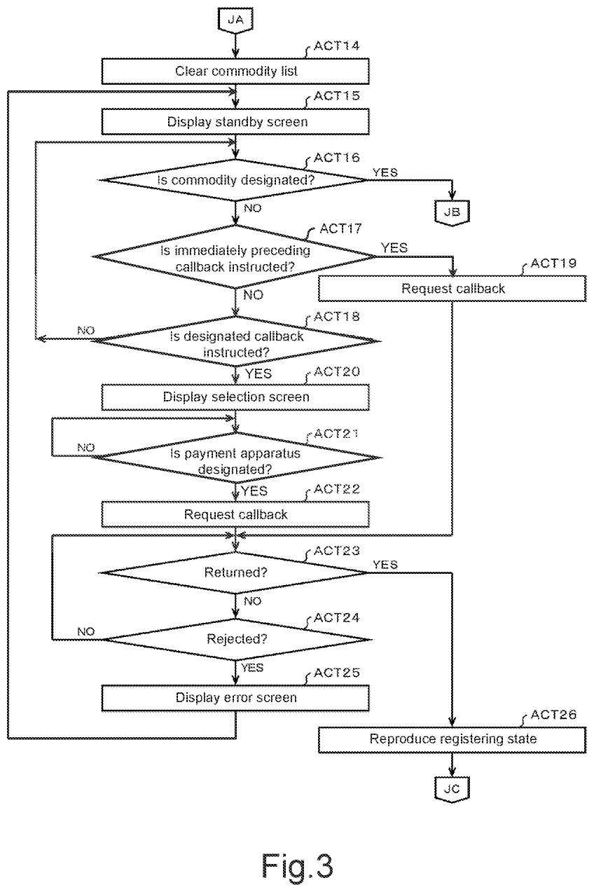

Next, the operation of the checkout system 1 configured as described above will be described. When the registration apparatus 10 is activated in an operating mode for executing the registration processing, the processor 101 executes the registration processing to be described below according to the registration program 1031. FIGS. 2 and 3 are flowcharts showing the registration processing of the processor 101. Note that the content of the processing to be described below is an example, and it is possible to change the order of some of the processing, omit some of the processing, or add another processing as appropriate.

In ACT1 of FIG. 2, the processor 101 clears a commodity list. The commodity list is a list of purchased commodities registered as a target of one transaction, and is stored in the main memory 102 or the auxiliary storage device 103. In ACT2, the processor 101 displays a registration screen on the touch panel 106. The registration screen is a screen indicating the registration state of the purchased commodities in the registration processing.

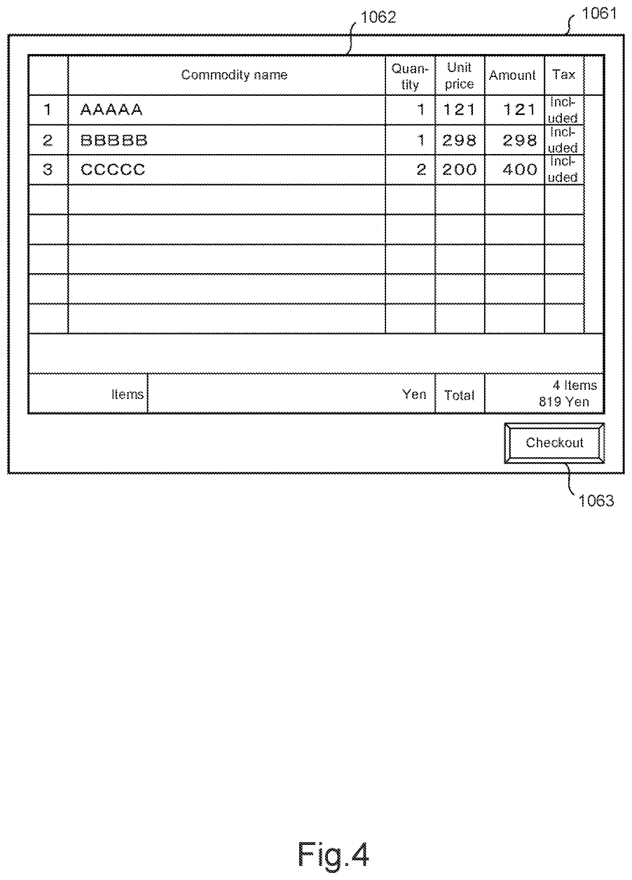

FIG. 4 is a diagram showing a registration screen 1061. The registration screen 1061 displays an image 1062 and a button 1063. The image 1062 represents the details of a registered transaction. In FIG. 4, the image 1062 shows a state in which one commodity with a commodity name of “AAAAA”, one commodity with a commodity name of “BBBBB”, and two commodities with a commodity name of “CCCCC” are included in the commodity list as purchased commodities. Further, the registration screen 1061 displays the button 1063. The button 1063 is a soft key for receiving an operation of a transition instruction, i.e., a transition instruction to payment processing in the payment apparatus. Note that the details represented by the image 1062 are sequentially changed depending on the state of the commodity list. In the above ACT2, the commodity list is in the cleared state, and thus the processor 101 sets the image 1062 to the state in which the information relating to the purchased commodities is not displayed.

In ACT5 of FIG. 2, the processor 101 waits until a commodity to be registered as a purchased commodity is designated. The customer picks up a commodity to be purchased from the sales floor, brings the commodity to the checkout corner, and passes the commodity to a clerk in charge of the operation of the registration apparatus 10. The clerk performs a registration operation for designating each commodity passed by the customer as a registration target. The registration operation includes, for example, an operation of causing the scanner 104 to read a bar code displayed on the commodity, an operation of touching the touch panel 106 to designate the commodity, or the like. If such a registration operation is performed by the clerk, the processor 101 determines that the commodity has been designated (YES in ACT3). The processing of the processor 101 then proceeds to ACT4.

In ACT4 of FIG. 2, the processor 101 acquires the commodity code for identifying the commodity designated as described above. The processing of the processor 101 for acquiring the commodity code may be processing similar to that performed by another conventional registration apparatus. In other words, the processor 101 extracts, for example, a commodity code included in the code data obtained by reading the code symbol by the scanner 104. The processor 101 also acquires the commodity code associated with a button operated on the GUI screen of the touch panel 106, for example. The commodity code is, for example, a Japanese article number (JAN) code.

In ACT5, the processor 101 updates the commodity list stored in, for example, the main memory 102 or the auxiliary storage device 103 to include the commodity code obtained as described above. Thus, the transaction as a payment target is registered. The processor 101 performs information processing based on the registration program 1031, so that the computer including the processor 101 as the central part functions as registration means. In ACT6, the processor 101 displays the registration screen 1061 (see FIG. 4). In other words, the processor 101 displays the registration screen 1061 updated so as to represent the registration state in accordance with the commodity list updated in ACT5, for example.

In ACT7, the processor 101 determines whether or not a new commodity has been designated. If it is determined that a new commodity has not been designated (NO in ACT7), the processing of the processor 101 proceeds to ACT8. In ACT8, the processor 101 terminates the registration processing and determines whether or not an operator (clerk) has issued a transition instruction for declaring the transition to the payment processing in the payment apparatus 20. If an operation for the transition instruction has not been received by the button 1063, the processor 101 determines that a transition instruction has not been issued (NO in ACT8). The processing of the processor 101 then returns to ACT7. In such a manner, the processor 101 waits for a new commodity code to be acquired or a transition instruction to be issued in ACT7 and ACT8. Subsequently, in ACT7, if a new commodity code is acquired, the processor 101 determines that a commodity has been newly designated (YES in ACT7). The processor 101 then performs the processing of ACT4 to ACT6 again, and returns to the standby states of ACT7 and ACT8. Thus, the processor 101 registers the commodity as a purchased commodity in accordance with the repetition of the registration operations.

When the clerk completes the registration operation to designate all of the commodities passed by the customer as purchased commodities, the clerk issues a transition instruction by a predetermined operation such as touching the button 1063 of the registration screen 1061, for example (see FIG. 4). The processor 101 then determines in ACT8 of FIG. 2 that a transition instruction has been issued (YES in ACT8). The processing of the processor 101 then proceeds to ACT9. In ACT9, the processor 101 generates payment data. The processor 101 stores the payment data in the main memory 102 or the auxiliary storage device 103. The processor 101 includes a predetermined registration machine identifier to identify each registration apparatus 10 and the commodity list to the payment data. The processor 101 may calculate a payment amount and include it in the payment data. What information is included in the payment data by the processor 101 may be optionally determined by the designer of the registration apparatus 10, for example.

In ACT10, the processor 101 transmits the payment data generated as described above. Specifically, the processor 101 transmits the payment data from the communication device 110 to the LAN 30 to be directed to one of the payment apparatuses 20. Note that the processor 101 determines which one of the payment apparatuses 20 is the destination in accordance with predetermined rules. The rules may be optionally determined by, for example, the designer of the registration apparatus 10. As one example of the rules, a specific payment apparatus 20 predetermined as one of the two payment apparatuses is constantly set as a destination. As another example of the rules, one payment apparatus 20 randomly selected from the payment apparatuses 20 is set as a destination. As another example of the rules, a single payment apparatus 20 designated by the operator operating the registration apparatus 10 is set as a destination. Thus, the processor 101 executes the information processing based on the registration program 1031, so that the computer including the processor 101 as the central part functions as transmission means.

The payment data, which is transmitted to the payment apparatus 20 serving as a destination through the LAN 30, is received by the communication device 209 of the payment apparatus 20. Then, the processor 201 of the payment apparatus 20 determines whether or not payment processing can be started. If the payment processing can be started, the processor 201 then transmits the reception data so as to notify the registration apparatus 10 of the fact that the payment data has been received. The reception data includes, for example, a command indicating that the payment data has been received and a payment machine identifier predetermined to identify each payment apparatus 20. The processor 201 then transmits the reception data from the communication device 209 to the LAN 30 to be directed to the registration apparatus 10 identified by the registration machine identifier included in the received payment data. Further, the processor 201 starts payment processing based on the payment data. The processor 201 forwards the payment data if it is unable to start the payment processing. Specifically, the processor 201 forwards the payment data to a predetermined forwarding destination as one of the other payment apparatus 20 and the registration apparatus 10. For example, if none of the two payment apparatuses 20 is ready to start the payment processing, the payment data is forwarded in the order of the registration apparatus 10, one of the payment apparatuses 20, the other one of the payment apparatuses 20, and the registration apparatus 10. If the registration apparatus 10 is used as the forwarding destination, the processor 201 sets, as a forwarding destination, the registration apparatus 10 identified by the registration machine identifier represented in the payment data. Therefore, the payment data will be returned to the registration apparatus 10 that has transmitted it.

Now in the registration apparatus 10, the processor 101 transmits the payment data in ACT10 of FIG. 2, as described above. Subsequently, the processing of the processor 101 proceeds to ACT11. In ACT11, the processor 101 determines whether or not the payment data has been returned. If the payment data has not been received by the communication device 110, the processor 101 determines that the payment data has not been returned (NO in ACT11). The processing of the processor 101 then proceeds to ACT12. In ACT12, the processor 101 determines whether or not the payment data has been received. If the reception data has not been received by the communication device 110, the processor 101 then determines that the payment data has not been received (NO in ACT12). The processing of the processor 101 then returns to ACT11. In such a manner, the processor 101 waits in ACT11 and in ACT12 until the transmitted payment data (see ACT10) is returned from the payment apparatus 20 or the payment data is received by the payment apparatus 20. If the payment data is returned from the payment apparatus 20 as described above and then received by the communication device 110, the processor 101 determines that the payment data has been returned (YES in ACT11). The processing of the processor 101 then returns to ACT10. In other words, the processor 101 transmits the payment data again to request the payment processing to be executed again. Note that the processor 101 may prompt the operator to perform confirmation using display of a screen or the like, and then transmit the payment data again in response to an instruction from the operator.

On the other hand, if the reception data is transmitted from the payment apparatus 20 as described above and received by the communication device 110, the processor 101 determines that the payment data has been received (YES in ACT12). The processing of the processor 101 then proceeds to ACT13. In ACT13, the processor 101 stores the payment machine identifier included in the reception data in the main memory 102 or the auxiliary storage device 103. Subsequently, the processing of the processor 101 then proceeds to ACT14 of FIG. 3. In other words, the processor 101 determines the payment apparatus 20, which takes over the execution of the payment processing, as the payment apparatus 20 identified by the payment machine identifier included in the reception data. The processor 101 executes the information processing based on the registration program 1031, so that the computer including the processor 101 as the central part functions as determination means.

In ACT14 of FIG. 3, the processor 101 clears the commodity list. This causes the registration apparatus 10 to enter a standby state for the registrations start of a new transaction. In ACT15, the processor 101 causes the touch panel 106 to display a standby screen. The standby screen is a screen indicating that the apparatus is in the standby state.

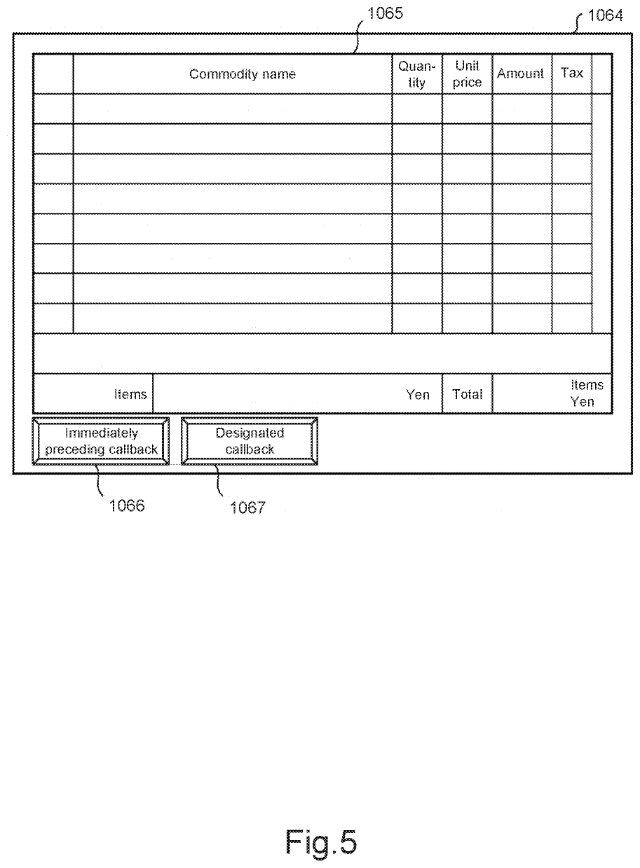

FIG. 5 is a diagram showing a standby screen 1064. The standby screen 1064 displays an image 1065 and buttons 1066 and 1067. The image 1065 represents a fixed display object except for the display information that varies according to the commodity list in the image 1062 of the registration screen 1061. As a result, the image 1065 indicates that purchased commodities have not yet been registered. Each of the buttons 1066 and 1067 is a soft key for receiving an operation for an instruction to execute a payment data callback.

The processing of the processor 101 transfers to the standby state in ACT16 to ACT18 of FIG. 3 with the above-mentioned standby screen 1064 being displayed. In ACT16, the processor 101 determines whether or not a commodity to be registered as a purchased commodity is designated. If the processor 101 determines that a commodity to be registered is not designated (NO in ACT16), the processing of the processor 101 proceeds to ACT17. In ACT17, the processor 101 determines whether or not an instruction has been issued to execute a callback of the payment data lastly transmitted, which will be hereinafter referred to as an immediately preceding callback. If the operation for an instruction to execute an immediately preceding callback is not received by the button 1066, the processor 101 then determines that an instruction to execute an immediately preceding callback has not been issued (NO in ACT17). The processing of the processor 101 then proceeds to ACT18. In ACT18, the processor 101 determines whether or not an instruction has been issued to execute a callback of the payment data with a target payment apparatus 20 designated, which will be hereinafter referred to as a designated callback. If the operation for an instruction to execute a designated callback is not received by the button 1067, the processor 101 then determines that an instruction to execute a designated callback has not been issued (NO in ACT18). The processing of the processor 101 then returns to ACT16. In such a manner, the processor 101 waits until a commodity is designated or an instruction to execute the immediately preceding callback or the designated callback is issued, in the standby state in ACT16 to ACT18.

If the clerk starts the registration of the transaction relating to the next customer, the clerk performs the registration operation for designating a commodity passed from the that customer as a registration target. If such a registration operation is performed, the processor 101 determines that the commodity is designated (YES in ACT16). The processor 101 then executes ACT4 and subsequent processing of FIG. 2 in the same manner as described above.

Meanwhile, if an immediately preceding callback is necessary, the clerk instructs the execution of the immediately preceding callback by a predetermined operation such as touching the button 1066 on the standby screen 1064 in FIG. 5, for example. If the operation of instructing the execution of the immediately preceding callback is received by the button 1066, the processor 101 determines that the execution of the immediately preceding callback is instructed (YES in ACT17). The processing of the processor then proceeds to ACT19. In such a manner, the processor 101 executes the information processing based on the registration program 1031, so that the computer including the processor 101 as the central part functions as operation means.

In ACT19, the processor 101 requests a callback to the payment apparatus 20, which receives the payment data transmitted when the processing of ACT10 of FIG. 2 has been lastly executed. The processor 101 transmits request data including, for example, a command indicating a callback request and a registration machine identifier from the processor 101 to the LAN 30 to be directed to the payment apparatus 20 identified by the payment machine identifier stored in ACT13 of FIG. 2. The callback request is for requesting the payment apparatus 20 to stop the payment processing based on the payment data transmitted when the processing in ACT10 has been lastly executed and to return the payment data. In other words, the processor 101 executes the information processing based on the registration program 1031, so that the computer including the processor 101 as the central part functions as instruction means.

Meanwhile, if a designated callback is necessary, the clerk instructs the execution of the designated callback by a predetermined operation such as touching the button 1067 on the standby screen 1064 in FIG. 5, for example. If the operation of instructing the execution of the designated callback is received by the button 1067, the processor 101 determines that the execution of the designated callback is instructed (YES in ACT18). The processing of the processor 101 then proceeds to ACT20. In ACT20, the processor 101 causes the touch panel 106 to display a selection screen. The selection screen is a screen for allowing the operator to select a payment apparatus 20 to be called back.

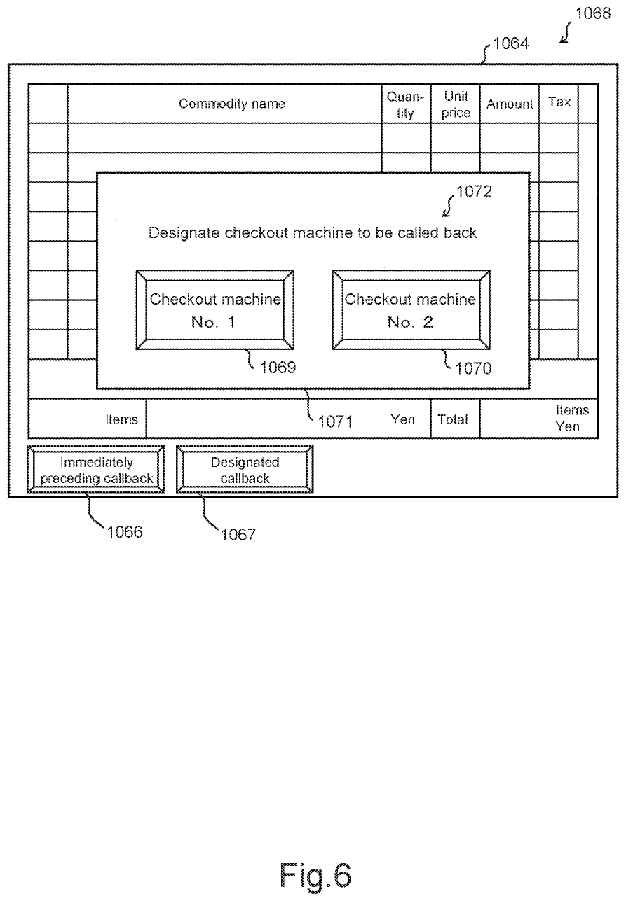

FIG. 6 is a diagram of a selection screen 1068. The selection screen 1068 is a screen in which a window 1071 is superimposed on the standby screen 1064 of FIG. 5. The window 1071 displays a character string 1072 and buttons 1069 and 1070. The character string 1072 is a character message that prompts the operator to select a payment apparatus 20. The buttons 1069 and 1070 are soft keys for receiving a designation of the payment apparatus 20 to be called back.

When the selection screen 1068 is displayed, the clerk designates the payment apparatus 20 by a predetermined operation such as touching one of the buttons 1069 and 1070, for example. In ACT21 of FIG. 3, the processor 101 waits until the payment apparatus 20 is designated. If an operation for designating the payment apparatus 20 is received by the buttons 1069 and 1070, the processor 101 determines that the payment apparatus 20 has been designated (YES in ACT21). The processing of the processor 101 then proceeds to ACT22.

In ACT22, the processor 101 requests a callback for the designated the payment apparatus 20. The processor 101 transmits the request data including, for example, a command indicating a callback request and a registration machine identifier from the communication device 110 to the LAN 30 to be directed to the designated the payment apparatus 20.

The processing of the processor 101 proceeds to ACT23 after the callback request is transmitted in ACT19 or ACT22. In ACT23, the processor 101 determines whether or not the payment data has been returned. If no payment data is received by the communication device 110, the processor 101 then determines that no payment data is returned (NO in ACT23). The processing of the processor 101 then proceeds to ACT24. In ACT24, the processor 101 determines whether or not the callback request has been rejected. If the communication device 110 has not received rejection data to be described later, the processor 101 then determines that the callback request has not been rejected (NO in ACT24). The processing of the processor 101 then returns to ACT23. In such a manner, the processor 101 waits for the return of the payment data or the rejection of the callback in ACT23 and ACT24.

In the payment apparatus 20, when the processor 201 starts the payment processing as described above, the processor 201 advances the payment processing while being operated by the customer. When the request data for the callback request is received by the communication device 209, the processor 201 determines whether or not the callback is acceptable on the basis of the progress of the payment processing. If a predetermined limit timing has not elapsed, the processor 201 determines that the callback request is acceptable. The processor 201 then stops the payment processing and transmits the payment data to the registration apparatus 10. However, if the predetermined limit timing has elapsed, the processor 201 determines that the callback request is unacceptable, continues the payment processing, and transmits the predetermined rejection data to the registration apparatus 10. Note that the predetermined limit timing is, for example, a timing at which the input of cash to the automated change machine 204 is started.

If the rejection data is received by the communication device 110, the processor 101 determines that the callback request has been rejected (determines YES in ACT24). The processor 101 then proceeds to ACT25. In ACT25, the processor 101 causes the touch panel 106 to display an error screen. The error screen is a screen for notifying the operator of the fact that the callback is impossible. After that, if a predetermined error display period ends, the processing of the processor 101 returns to ACT15. The processor 101 then repeats ACT15 and subsequent processing in the same manner as described above. Note that the error display period is, for example, a period during which the elapsed time after the error screen is displayed reaches a specified time. Alternatively, the error display period is, for example, a period until a predetermined operation for declaring that the operator confirms that the error has occurred is performed.

If the communication device 110 receives the payment data transmitted from the payment apparatus 20 in response to the callback request, the processor 101 determines that the payment data has been returned (YES in ACT23). The processing of the processor 101 then proceeds to ACT26. In ACT26, the processor 101 performs predetermined processing such as writing back the commodity list included in the payment data to the main memory 102 or the auxiliary storage device 103, to reproduce the registering state prior to transmitting the payment data. Note that the specific processing here may be similar to the processing at the time of a callback in a conventional semi-self-service checkout system, for example. The processor 101 then executes the processing of ACT6 of FIG. 2. In this ACT6, for example, if the processor 101 calls back the payment data transmitted to the payment apparatus 20 when the registration screen 1061 is in the state shown in FIG. 4, the registration screen 1061 in the state shown in FIG. 4 will be displayed on the touch panel 106. After that, the processor 101 executes ACTT and subsequent processing in the manner similar to that described above. In such a manner, the processor 101 executes the information processing based on the registration program 1031, so that the computer including the processor 101 as the central part functions as acquisition means and control means.

As described above, regarding the immediately preceding callback, the registration apparatus 10 executes a callback from the payment apparatus 20 that has received the payment data lastly transmitted before that, in response to a predetermined operation by one action of the operator, such as a touch to the button 1066 (see FIG. 5). Therefore, the clerk who operates the registration apparatus 10 only needs to perform the operation by one action when the callback relating to the most recently registered transaction is performed, and the burden on that operation is reduced as compared with the case where the operation of designating the payment apparatus 20 to be called back is required as in the case of the designated callback.

Various modifications of this embodiment are possible as follows. The processor 101 may determine a payment apparatus 20 for executing the payment processing in accordance with predetermined rules or in accordance with a designation by the clerk, and transmit the payment data to the payment apparatus 20. In this case, the processor 101 may store the payment machine identifier of the payment apparatus 20, which is the destination of the payment data, in the main memory 102, and may use the payment apparatus 20 identified by the payment machine identifier as a target of the immediately preceding callback.

The designated callback may be disabled.

Even after the registration of a new transaction is started, if the payment data of the transaction is not yet transmitted, the immediately preceding callback may be executable. In this case, for example, the processor 101 keeps a commodity list relating to the transaction in progress in the main memory 102 or the auxiliary storage device 103. Subsequently, the processor 101 only needs to store a commodity list as well, which is reproduced from the called-back payment data, in the main memory 102 or the auxiliary storage device 103. For example, the processor 101 may resume the processing for registration relating to the transaction to be called back, and, after completing such processing, resume the processing for registration relating to the interrupted transaction.

Some or all of the functions implemented by the processor 101 through the information processing may be achieved by hardware that executes the information processing not based on a program, such as a logic circuit. Alternatively, each of the above-mentioned functions may be achieved by combining software control with hardware such as the logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A registration apparatus that performs registration processing for registering information of a commodity as a transaction target and transmits payment data including the registered information of the commodity to any one of a plurality of payment apparatuses to perform payment processing for the transaction, the registration apparatus comprising:
an input device that receives a callback operation for instructing the payment apparatus to return the transmitted payment data, the callback operation being performed by an operator;
a memory that stores transaction information including a commodity list for storing the information of the commodity for the registration processing;
a communication device that performs communication for exchanging data with the plurality of payment apparatuses; and
a processor that
includes, when the information of the commodity is acquired in a state of the registration processing, the acquired information of the commodity in the commodity list to update the commodity list stored in the memory,
generates the payment data including the commodity list stored in the memory and transmits the generated payment data to a predetermined payment apparatus of the plurality of payment apparatuses via the communication device,
determines which payment apparatus of the plurality of payment apparatuses is a payment apparatus that takes over execution of the payment processing based on the transmitted payment data,
instructs the payment apparatus lastly determined to stop the payment processing based on the transmitted payment data via the communication device in response to the reception of the callback operation by the input device,
calls back the transmitted payment data from the payment apparatus, to which the instruction has been issued, via the communication device, and
stores the commodity list included in the called-back payment data in the memory again to return to the state of the registration processing before the payment data is transmitted.

2. The registration apparatus according to claim 1, wherein
the processor transmits the payment data to a payment apparatus that is to execute the payment processing in accordance with a predetermined rule.

3. The registration apparatus according to claim 2, wherein
the processor
acquires reception data from the payment apparatus via the communication device, and
determines a payment apparatus that takes over the execution of the payment processing on a basis of an identifier of the payment apparatus, the identifier being included in the acquired reception data.

4. The registration apparatus according to claim 1, wherein
the processor transmits the payment data to a payment apparatus determined as a payment apparatus that is to execute the payment processing from the plurality of payment apparatuses via the communication device.

5. The registration apparatus according to claim 4, wherein
the processor determines the determined payment apparatus as a payment apparatus that takes over the execution of the payment processing.

6. The registration apparatus according to claim 1, wherein
the processor
receives reception data from a payment apparatus that takes over the execution of the payment processing based on the payment data via the communication device, and
stores an identifier of the payment apparatus in the memory, the identifier being included in the reception data.

7. The registration apparatus according to claim 6, wherein
the processor transmits, when the input device receives the callback operation, request data for instructing a stop of the payment processing and a callback of the payment data to the payment apparatus identified by the identifier of the payment apparatus, the identifier being stored in the memory.

8. The registration apparatus according to claim 6, wherein
the input device includes a first button and a second button that receive the callback operation of an operator, and
the processor
transmits, when the first button receives the callback operation of the operator, request data for instructing a stop of the payment processing and a callback of the payment data to the payment apparatus identified by the identifier of the payment apparatus, the identifier being stored in the memory, and
displays, when the second button receives the callback operation of the operator, a selection screen for selecting any one of the plurality of payment apparatuses on a display of the input device.

9. The registration apparatus according to claim 8, wherein
the processor transmits the request data to the selected payment apparatus when the payment apparatus is selected via the selection screen.

10. A payment data callback method for a registration apparatus that performs registration processing for registering information of a commodity as a transaction target and transmits payment data including the registered information of the commodity to any one of a plurality of payment apparatuses to perform payment processing for the transaction, the callback method comprising:
storing transaction information including a commodity list for storing the information of the commodity for the registration processing;
including, when the information of the commodity is acquired in a state of the registration processing, the acquired information of the commodity in the commodity list to update the commodity list stored in the memory;
generating the payment data including the commodity list stored in the memory and transmitting the generated payment data to a predetermined payment apparatus of the plurality of payment apparatuses via the communication device;
determining which payment apparatus of the plurality of payment apparatuses is a payment apparatus that takes over execution of the payment processing based on the transmitted payment data;
instructing the payment apparatus lastly determined to stop the payment processing based on the transmitted payment data via the communication device in response to a reception of a callback operation by an input device, the callback operation instructing the payment apparatus to return the transmitted payment data, the callback operation being performed by an operator;
calling back the transmitted payment data from the payment apparatus, to which the instruction has been issued, via the communication device; and
storing the commodity list included in the called-back payment data in the memory again to return to the state of the registration processing before the payment data is transmitted.
